(19) United States
(12) Patent Application Publication
(10) Pub. No.: US 2004/0198304 A1
(43) Pub. Date: Oct. 7, 2004

(54) Fastening device for cellular phone

(76) Inventor: Chin-Yang Wang, Tainan Hsien (TW)

Correspondence Address: BACON & THOMAS, PLLC, 625 SLATERS LANE, FOURTH FLOOR, ALEXANDRIA, VA, 22314

(21) Appl. No.: 10/196,189

(22) Filed: Jul. 17, 2002

(51) Int. Cl. H04B 1/06

(52) U.S. Cl. 455/345; 455/90.1

(57) ABSTRACT

The invention is to provide a device for fastening a cellular phone, after placing a base of the device into a socket in the center console of an automobile, a wheel member fixed on the top of a threaded guide post engaged with the base is rotatable to cause a first sliding block to move either upward or downward along the threaded guide post for causing a second sliding block to move laterally outwardly as a longitudinal first guide elements of the first sliding block slide along the mated longitudinal second guide elements of the second sliding block until the outer surfaces of the second sliding blocks engage with an inner wall of the socket, thereby securing the device to the socket for fastening a cellular phone.

### FIELD OF THE INVENTION

The present invention relates to fastening device for cellular phone and more particularly to such a fastening device being adjustable to be adapted to secure to a socket on the center console of an automobile.

### BACKGROUND OF THE INVENTION

Electronic-based communication products (e.g., cellular phones) are used as a convenient and efficient communication tool in this fast changing, competitive society. It is also known that a cellular phone may be placed in one of different locations in a use or non-use state depending on environments. For example, the cellular phone may be held on the waist of the user or a pocket of clothes worn by the user, or placed in a suitable place within an automobile as illustrated in FIG. 1. As shown, a cellular phone 10 is placed on a top grip member 12 of a fastening device 11 by clipping. The fastening device 11 further comprises a cylindrical base 14 placed into one of sockets (two are shown in which one is for receiving a beverage can and the other is for receiving the fastening device 11) 101 on the center console of the automobile, and an intermediate post 13 interconnecting the base 14 and the grip member 12.

It is desired that the base 14 can be secured in the socket 101. In fact, however, it is not achievable in almost all cases. This is because a bore of the socket 101 is fixed after manufactured. As such, the bore of the socket 101 may be larger or smaller than a diameter of the base 14. Thus, it is impossible of placing the fastening device 11 in the socket 101 if the bore of the socket 101 is smaller than the diameter of the base 14. Alternatively, the placed fastening device 11 may be loose if the bore of the socket 101 is larger than the diameter of the base 14. Such nonconforming problem often frustrates users. Hence, such fastening device 11 is not practical. Thus improvement exists.

Thus, it is desirable to provide a fastening device being adjustable to be adapted to secure to a socket on the center console of an automobile in order to overcome the above drawback of the prior art.

### SUMMARY OF THE INVENTION

It is therefore an object of the present invention to provide a device for fastening a cellular phone comprising a base; a threaded guide post having a bottom engaged with a top surface of the base; a wheel member fixed on a top of the threaded guide post; a support having a bottom secured to the wheel member and a top secured to a grip member which is in turn secured to the cellular phone by clipping; a first sliding block sleeved on and threadedly secured to the threaded guide post, the first sliding block having two slanted surfaces wherein a distance between top ends of the slanted surfaces is larger than that of bottom ends thereof, the first sliding block further including a longitudinal first guide element on either slanted surface; and two second sliding blocks each having a slanted surface parallel to the corresponding one of the first sliding block and a mated longitudinal second guide element on the slanted surface facing the longitudinal first guide element so that the second and the first sliding blocks are capable of matingly, slidably securing together; whereby in response to a placing of the base into a socket within an automobile, the wheel member is rotatable to cause the first sliding block to move either upward or downward along the threaded guide post for causing the second sliding blocks to move laterally outwardly as the longitudinal first guide elements slide along the mated longitudinal second guide elements until outer surfaces of the second sliding blocks engage with an inner wall of the socket, thereby securing the fastening device to the socket. By utilizing this fastening device, the problem of nonconforming between the bore of the socket and the width or the diameter of the base of the fastening device as experienced in the prior art is solved.

The above and other objects, features and advantages of the present invention will become apparent from the following detailed description taken with the accompanying drawings.

### BRIEF DESCRIPTION OF THE DRAWINGS

FIG. 1 is a perspective view of a conventional device for fastening a cellular phone on an automobile;

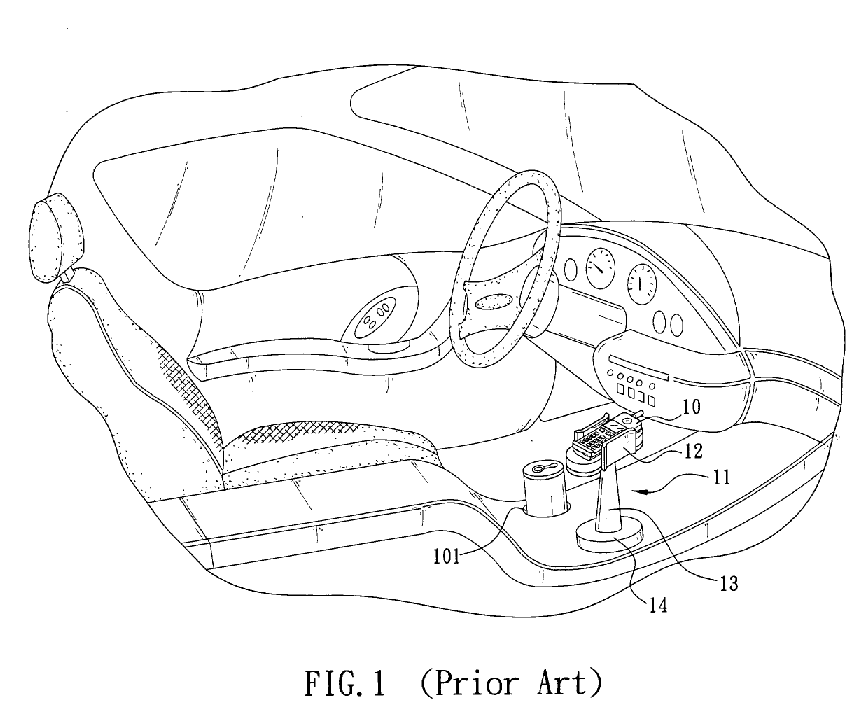

FIG. 2 is an exploded view of a fastening device for cellular phone according to the invention;

FIG. 3 is a perspective view of the assembled fastening device;

FIG. 4 is a cross-sectional view of the FIG. 3 where the fastening device is being mounted in a socket in the center console of an automobile; and

FIG. 5 is a view similar to FIG. 4 where the fastening device has been adjusted for securing to the socket.

### DETAILED DESCRIPTION OF THE PREFERRED EMBODIMENTS

The invention is directed to a fastening device for cellular phone. It is envisaged that the invention can solve the conventional problem of nonconforming between a socket and the fastening device, i.e., unable to place the fastening device in the socket if the bore of the socket is smaller than the diameter of a base of the fastening device or the placed fastening device may be loose if the bore of the socket is larger than the diameter of the base.

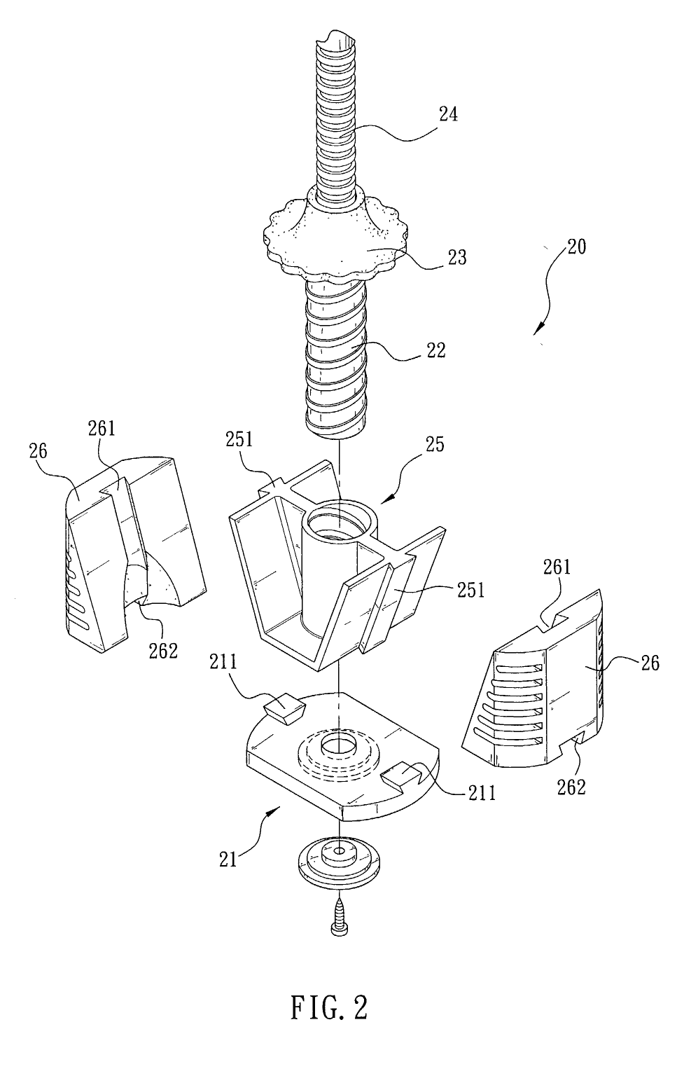

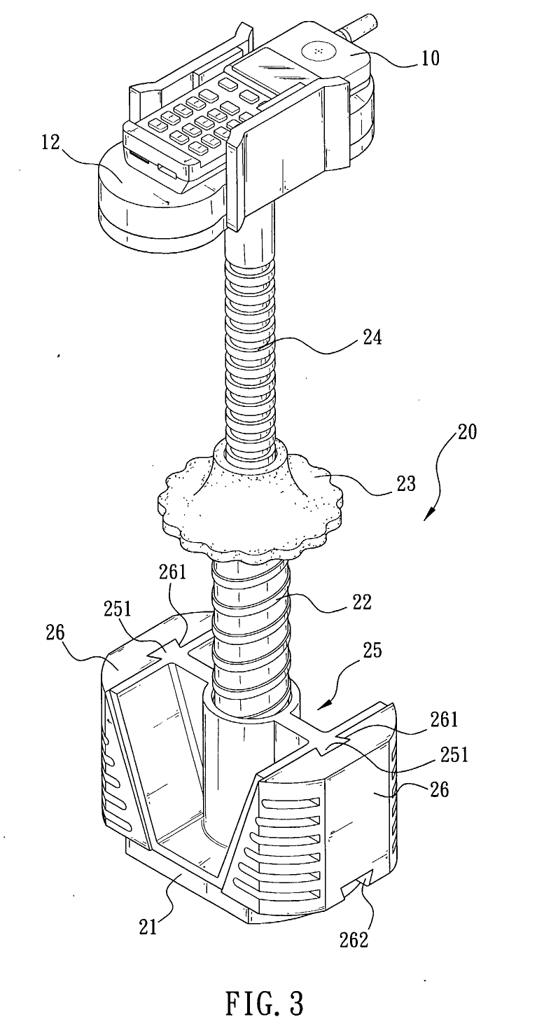

Referring to FIGS. 2, FIG. 3, FIG. 4 and FIG. 5, there is shown a fastening device 20 for a cellular phone 10 in accordance with the invention. The fastening device 20 comprises a base 21, a threaded guide post 22 having a bottom engaged with a top surface of the base 21, a wheel member 23 fixed on a top of the threaded guide post 22, and a support (such as flexible pipe 24) having a bottom secured to the wheel member 23 and a top secured to a grip member 12 which is in turn secured to the cellular phone 10 by clipping. It is appreciated by those skilled in the art that the flexible pipe 24 may be replaced by another suitable device without departing from the scope and spirit of the invention.

For the purpose of adjusting a width of the base 21, the base 21 further comprises a projection 211 at either side of the top surface and the fastening device 20 further comprises a first sliding block 25 sleeved on and threadedly secured to the threaded guide post 22. The first sliding block 25 has a cross-section of substantially trapezoid wherein a distance between top ends of two slanted surfaces is larger than that of bottom ends thereof. The first sliding block 25 comprises a longitudinal flange 251 on either slanted surface. The fastening device 20 further comprises two second sliding blocks 26 each having a mated trough 261 on a slanted surface facing the longitudinal flange 251 (i.e., each slanted surface of the second sliding block 26 is parallel to the corresponding one of the first sliding block 25). The mated trough 261 can be slidably mated with the corresponding longitudinal flange 251 enabling the second sliding blocks 26 to be matingly and slidably secured together with the first sliding block 25. The second sliding block 26 further comprises a mated bottom groove 262 facing the projection 211, which can be slidably mated with the corresponding projection 211 and enables the base 21 to be matingly and slidably secured together with the second sliding blocks 26. This arrangement can make the sliding movement more smooth.

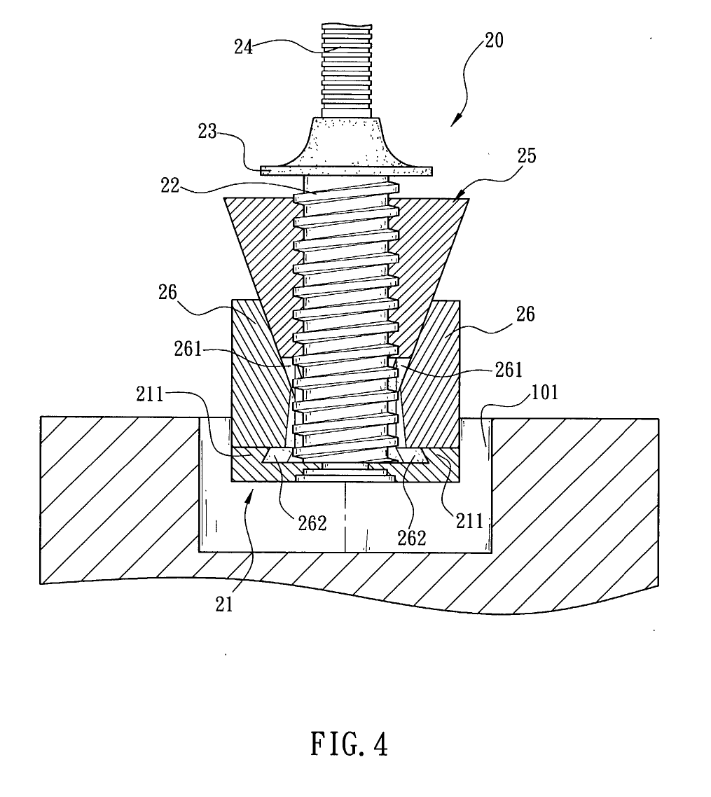

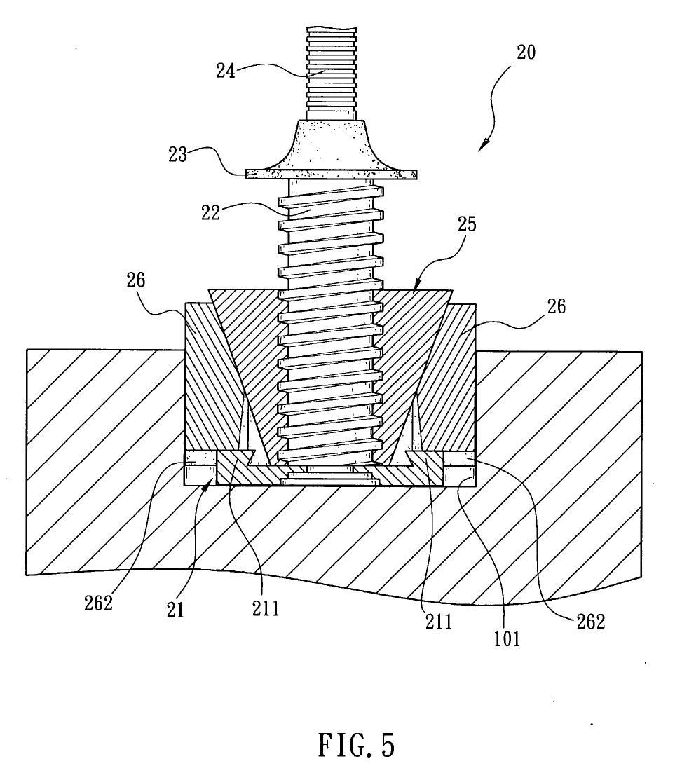

Referring to FIGS. 4 and 5, a width adjustment of the base 21 will now be described below. First, place the base 21 of the fastening device 20 into a socket 101 in the center console of an automobile. As stated above, the bore of the socket 101 may be larger or smaller than a width of the base 21. In either case, a user (e.g., driver) can rotate the wheel member 23 to simultaneously rotate the threaded guide post 22 and cause the first sliding block 25 to move upward or downward along the threaded guide post 22. In the embodiment, the first sliding block 25 moves downward. In response, the second sliding blocks 26 move laterally and outwardly as the longitudinal flanges 251 slide along the mated troughs 261. Such adjustment continues until flat portions of outer surfaces of the second sliding blocks 26 tightly engage with an inner wall of the socket 101. As a result, the fastening device 20 is secured to the socket 101. In brief, the invention can solve the problem of nonconforming between the bore of the socket and the width (or the diameter) of the base of the fastening device as experienced in the prior art.

While the invention has been described by means of specific embodiments, numerous modifications and variations could be made thereto by those skilled in the art without departing from the scope and spirit of the invention set forth in the claims.

What is claimed is:

1. A device for fastening a cellular phone comprising:
a base;
a threaded guide post having a bottom engaged with a top surface of the base;
a wheel member fixed on a top of the threaded guide post;
a support having a bottom secured to the wheel member and a top secured to a grip member which is in turn secured to a cellular phone by clipping;
a first sliding block sleeved on and threadedly secured to the threaded guide post, the first sliding block having two slanted surfaces wherein a distance between top ends of the slanted surfaces is larger than that of bottom ends thereof, the first sliding block further including a longitudinal first guide element on either slanted surface; and
two second sliding blocks each having a slanted surface parallel to the corresponding one of the first sliding block and a mated longitudinal second guide element on the slanted surface facing the longitudinal first guide element, which enables the second sliding blocks to be matingly and slidably secured together with the first sliding block;
whereby the wheel member is rotatable to cause the first sliding block to move either upward or downward along the threaded guide post for causing the second sliding block to move laterally outwardly as the longitudinal first guide elements slide along the mated longitudinal second guide elements.

2. The device of claim 1, wherein each of the longitudinal first guide elements is a flange and each of the mated longitudinal second guide elements is a trough.

3. The device of claim 1, wherein the base further comprises a third guide element at either side of the top surface and each of the second sliding blocks further comprises a mated bottom fourth guide element facing the third guide element so that the base is matingly and slidably secured together with the second sliding blocks as the third guide elements slide along the fourth guide elements.

4. The device of claim 3, wherein each of the third guide elements is a projection and each of the fourth guide elements is a groove.

5. The device of claim 1, wherein the support is a flexible pipe.
